(19) United States
(12) Patent Application Publication
(10) Pub. No.: US 2007/0283669 A1
(43) Pub. Date: Dec. 13, 2007

(54) Apparatus and a Method for Feeding Raw Material Into a Packaging Machine

(76) Inventors: Shlomo Nevo, Tel Aviv (IL); Pinchas Stambolski, Rishon-Lezion (IL)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/590,410

(22) PCT Filed:
(86) PCT No.: PCT/IL05/00239

(30) Foreign Application Priority Data
Mar. 1, 2004 (IL) 160664

(51) Int. Cl. B65B 31/04

(52) U.S. Cl. 53/473; 53/79

(57) ABSTRACT

A replaceable apparatus for carrying a pre-threaded material towards a packaging machine is disclosed. The apparatus is being connected to the machine via a suitable structure. Moreover, the apparatus is consisted of a filler appliance being a guide to the material, a separator and filling means for the filler of the bag.

### FIELD OF THE INVENTION

The present invention relates to an apparatus and to a method for feeding raw material (hereinafter: “material”) into a packaging machine.

### BACKGROUND OF THE INVENTION

In the packaging machine area, specifically in the Bagging and Air pillow manufacturing machines one of the more elaborated problems is the feeding system of raw material into the machine.

There are known apparatus and method trying to solve this problem of feeding a raw material into a machine, as for this purpose an open bag has to be formed which has to be filled with adequate filler.

The relevant prior art is described and claimed e.g. in U.S. Pat. Nos. 5,167,107, 5,640,834, 5,942,076, 6,178,725, 6,553,744, 6,582,800 and 6,659,15. Said specifications described various machines, apparatus and methods for solving the above problem.

This prior art describes and claims in particular the following two methods:
The first is the use of pre-welded material—a half-ready made bag that the machine fills with the necessary material and then welds the left opening thus forming a bag or a pillow. This method reduces the quality of the product as no versatility exists, therefore confines the user to a single type of product and when he wishes to modify the product, he needs to change the material as well.
The second solution uses preferably a one ply material, usually c-folded (center folded) material, and a series of rollers and levers the operator needs to thread the material through them, above and under creating the required path; this involves opening the cover threading manually and closing the cover every time the supply of material ends. This method is non user-friendly as the operator needs to deal with levers and rolls, threading the material through, separating the material with c-fold, 2-ply or a tube form material and making sure both ends reach the feeding draw rolls and are situated correctly. The method also requires much of the operator's time and is the reason for various mechanical problems.

It has thus been desirable to find an apparatus and a method which overcomes the above drawbacks i.e. this should not need:
1. to thread the material which operation takes a considerable amount of time from the operator.
2. of opening/closing covers/others which in addition to saving time reduces safety hazards and potential mechanical problems.
3. to attach/re-attach the material edges/2-ply and therefore creates a better alignment of the material with its future path.
4. to separate 2 ply/C-folded/tube materials as the air inlet pipe is inserted into the material and acts as a separator as well.

### SUMMARY OF THE INVENTION

The present invention thus consists in a replaceable apparatus carrying a pre-threaded material towards a packaging machine (hereinafter: “machine”); said apparatus being connected to said machine via a suitable structure.

The structure in accordance with the present invention may be an integral part of the apparatus or a separate part thereof, which separate part is connected to the apparatus. Said structure may be e.g. a connector.

Said replaceable apparatus consists in a filler appliance, preferably being an air inlet pipe, being a guide to the material, a separator and a filling means for the filler of the packaging, i.e. a bag.

The material in accordance with the present invention is advantageously a thermoplastic material such as polyethylene.

The filler in accordance with the present invention may be selected among air and any propelled material such as foam etc. The present invention described herein with reference to air however it is not restricted thereto.

The packaging machine is advantageously a bag-manufacturing machine. Thus, in a preferred embodiment of the present invention packaging is an air-bag.

The air inlet pipe being the apparatus is shaped advantageously to fit the specific socket/structure in the packaging machine and advantageously contains a quick release enabling unit.

The air inlet pipe is inserted to the material in the following manner:
The air inlet pipe is inserted into the material so it is wrapped all around by the material with the portion connecting the air inlet pipe to the machine extending outside of the material sheet. Around the air inlet pipe there are welds in the material that mechanically situate the air inlet pipe in its place. The welds surrounds the air inlet pipe and prevents movement from 3 different directions thus the air inlet pipe is not locked in place and the material can flow around it in one specific direction; Further, the welds may surround the air inlet pipe and prevent movement from 2 different directions therefore the air inlet pipe is not locked in place and the material can flow around it in only in 2 directions; thus when air flows through the air inlet pipe the material is directed only in one direction and so the air inlet pipe serves as a guide for the material as well.

Furthermore, said method may also be performed in that the welds that surround the air inlet pipe are located at its outline except for the portion where air exits the Air inlet pipe. In that portion the weld is located in some distance from the air inlet pipe. The excess material, welded in its edges, will be left. The excess material will be squeeze onto the air inlet pipe and held in place.

On the welded free side of the air inlet pipe the material is inserted and threaded through a recess, if present, which ensures the material's plies will stay in contact and keep the material's alignment. The other free side is connected to the machine.

Said air inlet pipe is preferably disposable.

The quick release enabling unit may be, e.g. a quick release T-shape unit, a quick release ring unit, etc.

Said air inlet pipe is may be provided with at least one recess projecting from the connection area containing at least one slot.

The air inlet pipe in accordance with the present invention may be composed from two parts, i.e. a transverse section dividing it to an upper part and a lower part which are later to be connected to one another by any suitable connecting means such as a snap-on structure.

In yet another embodiment of the air inlet pipe of the present invention the air inlet pipe may be composed from two parts i.e. the pipe itself and a connector enabling it to be connected to the machine.

The portion where the filler, preferably air, leaves the apparatus e.g. air inlet pipe, having an extended projection, having any suitable form and length, which projection serves as a guide to the material to reach the packaging machine e.g. the draw mechanism.

In the portion, of another embodiment, where air leaves the apparatus e.g. the air inlet pipe, excess material, if left is squeezed onto it; in this embodiment, when air blows through the tunnel of the machine and through the air inlet pipe the material is blown and thrown in the direction of the packaging machine's draw mechanism, thus reaching it.

In another embodiment the air inlet pipe is divided into two parts, upper and lower, by a transverse section. The threading of the air inlet pipe with 2-ply material or c-fold material is suitably performed by threading the upper and lower parts onto the material's edges, between each part's body and recess and forming a unit from these two parts by applying pressure, thus locking the snap-on structure, and adjoining them.

Should two flexible recesses project from the connector, one of them has a snap structure enabling it to connect to the second recess. Should the air inlet pipe comprise one slotted recess the method is advantageously performed by inserting the air inlet pipe into the material, connecting it to its connector part and while doing so threading the material through the slotted recess in the connector. It is well understood that recesses and the divided parts, namely body and connector, are only suggested embodiments however they are not essential and only optional.

Should the air inlet pipe comprises two flexible recesses the method is performed suitably by wrapping the air inlet pipe portion with the material, while the two recesses are in an “open” position; and After the air inlet pipe is situated binding the two recesses by using the snap structure therefore “closing” them.

The method in accordance with the present invention is suitably performed in either in a roll of thermoplastic material or in a fan folded thermoplastic material.

The air inlet pipe is advantageously made from a suitable thermoplastic material e.g. polyurethane, polypropylene, polyethylene, ABS, PVC etc.

The packaging machine for performing the method in accordance with the present invention has suitably a tunnel enabling filler, preferably air, flow through it into the apparatus preferably an air inlet pipe and where the connection between the tunnel and the apparatus is located in an easy access area. Said machine has preferably a sensor device for the apparatus e.g. micro switch, an optic eye sensor etc.

### BRIEF DESCRIPTION OF THE FIGURES

The present invention will now be illustrated with reference to the accompanying drawings without being limited by same. (Identical parts appearing in several drawings will be marked for sake of clarity by the same numerals).

Said drawings show:

FIG. 1: A packaging machine having an air inlet pipe in accordance with the present invention in a left cut out;

FIG. 2: air inlet pipe in an exploded view in accordance with the present invention;

FIG. 3: the air inlet pipe as described in FIG. 2 after the threading process;

FIG. 4: the air inlet pipe as described in FIG. 2 attached to the material;

FIG. 5: a machine having an air inlet pipe in accordance with FIG. 1 from an upper view;

FIG. 6: a cross-section of the machine of FIG. 5 in direction S-S′ as shown in said FIG. 5;

FIG. 7: a close up on the feeding area of a machine according to FIG. 1 fitted to the said air inlet pipe.

FIG. 8: another embodiment of an air inlet pipe in accordance with the present invention in which the said air inlet pipe is divided into 2 parts by a cross section. The 2 parts consist of the body of the Air inlet pipe and a connector part;

FIG. 9: a machine according to FIG. 1 illustrating insertion process;

FIG. 10: another embodiment of an air inlet pipe in accordance with the present invention pipe in which the area from which the air exits the air inlet pipe has 2 elongations of the “ceiling” and “floor” of the air inlet pipe along with a different method of attaching it to the material; and

FIG. 11: another embodiment of an air inlet pipe in accordance with the present invention containing two flexible recesses, which the material runs between and that afterwards will be attached (or closed).

### DESCRIPTION OF THE PREFERED EMBODIMENTS

The drawings are described hereunder as follows:

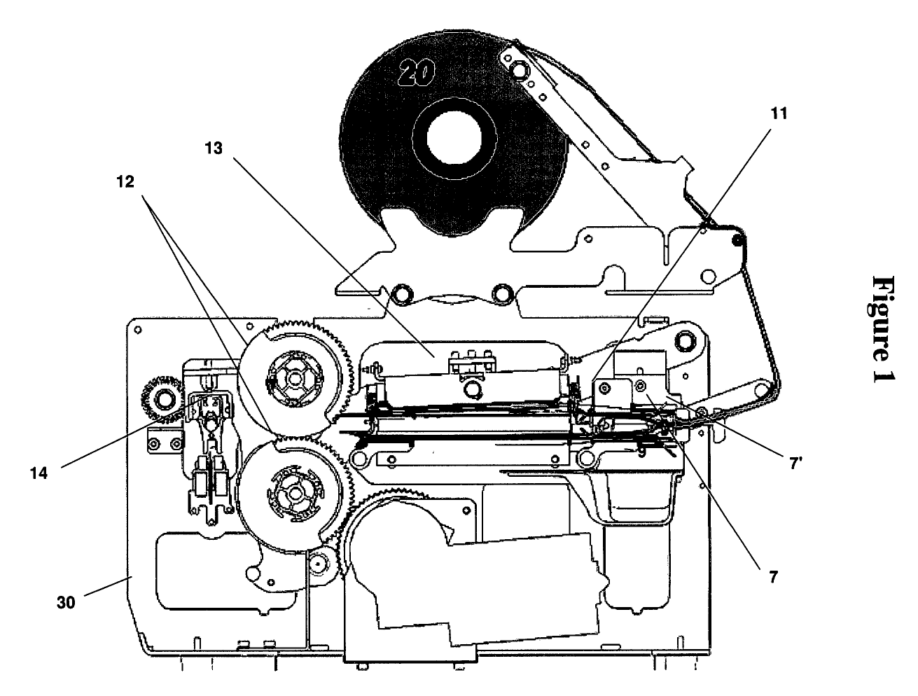

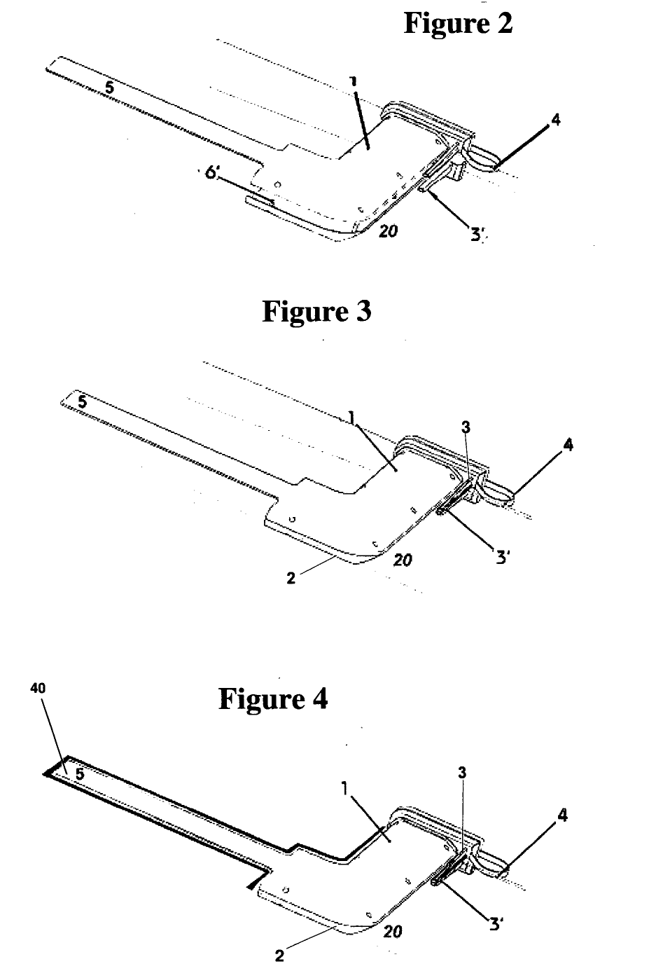

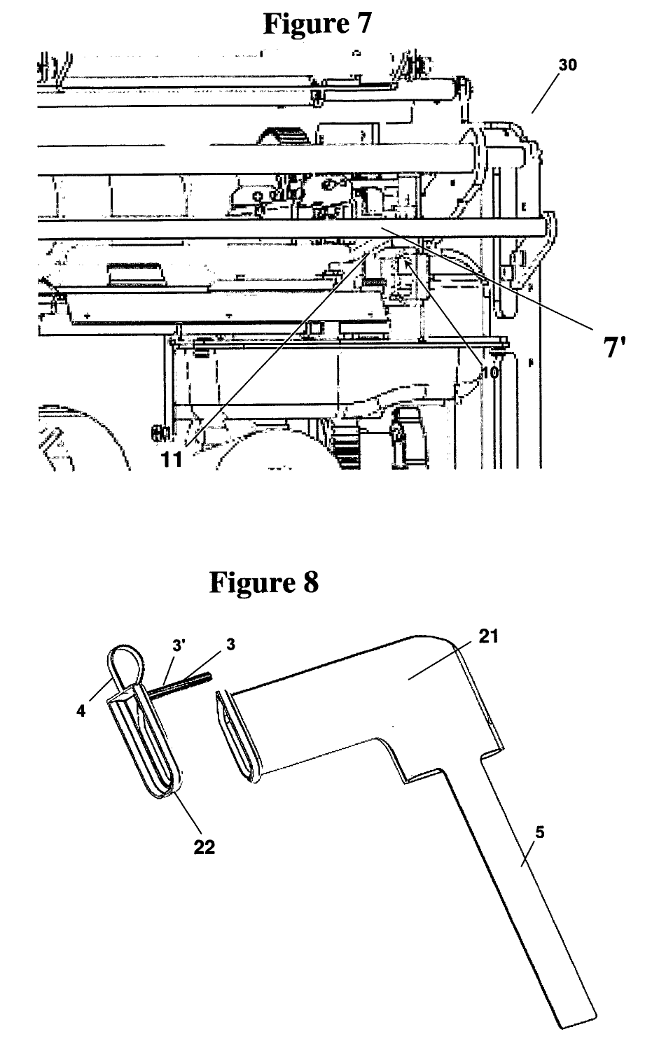

FIGS. 1, 5, and 6 show air inlet pipe 7 located in machine's socket 7′ (FIG. 7). Air from blower 8 is then flows through air tunnel 9 passes connector point 10 and enters air inlet pipe 7 (FIG. 6). Micro-switch 11 shown in FIG. 7 detects the presence of air inlet pipe 7 (FIG. 8). Air inlet pipe guide 5, shown in FIGS. 2 to 4, directs material 20 towards draw rollers 12 (FIG. 1). Material 20 is then being drawn and welded by machine 30 by welding elements 13 &14 (FIG. 1). In FIGS. 2 to 4 air inlet pipe 7 consists of two parts an upper part 1, and a lower part 2. Both parts have a recess 3 and 3′. Part 1 contains a quick release ring unit 4 and a material guide 5. Part 1 contains a female snap 6 and part 2 contains a male snap 6′. The parts of air inlet pipe 7 are inserted into material 20 as shown in FIG. 2.

Both parts 1 and 2 are pushed together, and maintained in that form by the “snap-on” structure 6 & 6′. The formed air inlet pipe 7 is thus threaded through material 20 as shown in FIG. 3.

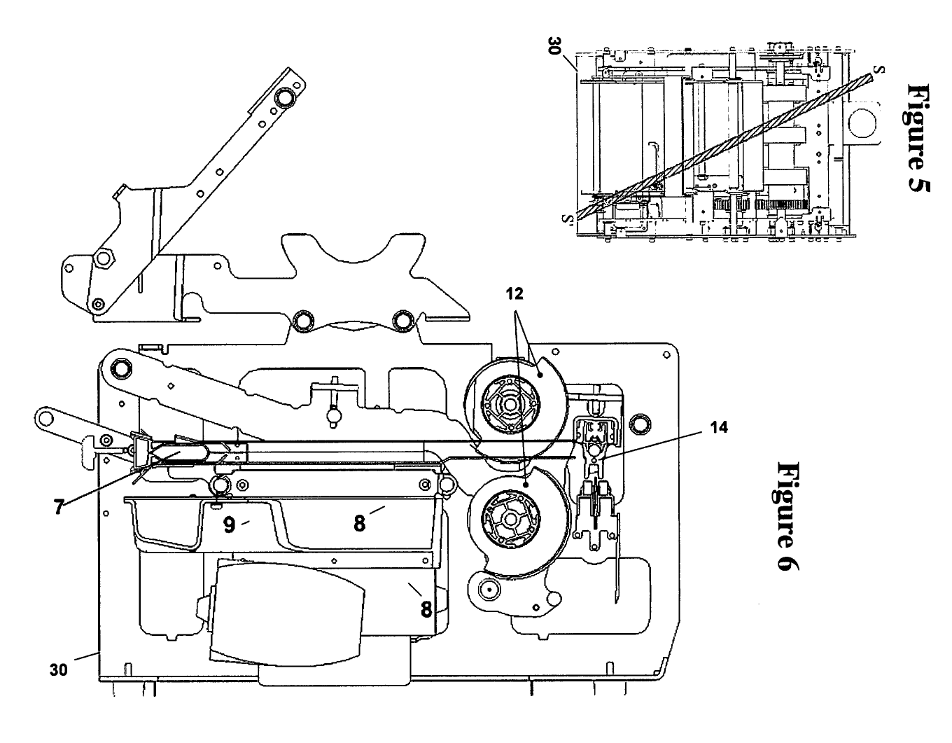

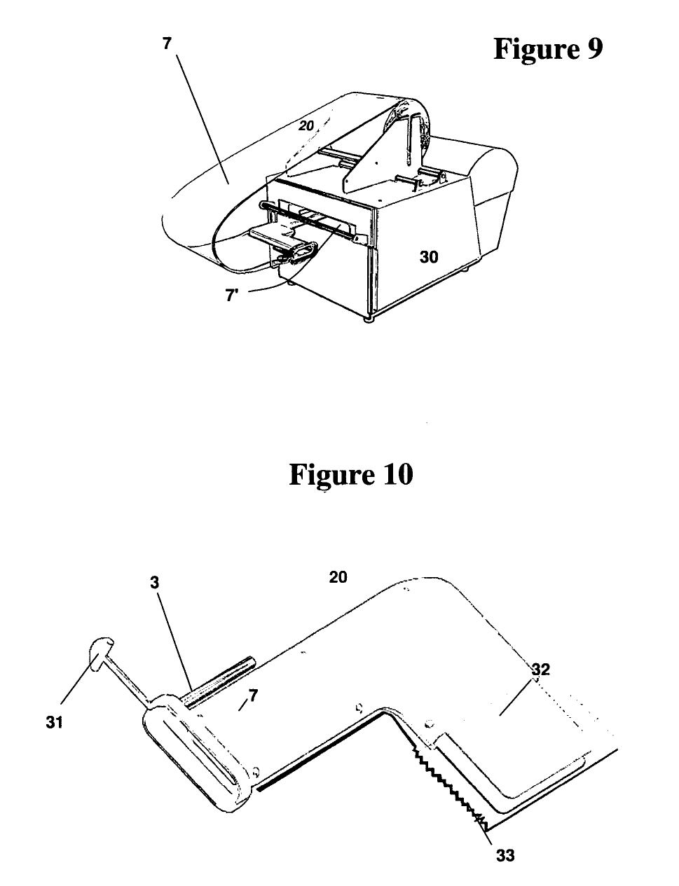

Material 20 is welded around outline of air inlet pipe 7—marked 40, in order to attach and maintain it in its position in material 20 (FIG. 4). In the manufacturing site material 20 along with air inlet pipe 7 is mounted onto machine 30 and the operator inserts air inlet pipe 7 to socket 7′ as show in FIG. 9. Air inlet pipe 7 shown in FIG. 8 is divided to two parts by a cross section. The resulting two parts are the body 21 of air inlet pipe and connector 22 by which the body connects to the machine. Body 21 has in the present embodiment a guide from type 5. It is possible that part 21 has a recess or a quick release unit however said embodiment is not shown in FIG. 8. Part 22 is suited to the structure of the machine 7′, and is able to connect to body 21. Part 22 has quick release ring unit 4 as shown in said FIG. 8, however it is not restricted to it. It is possible it has no recess at all, one recess or two recesses as in the present FIG. 8. It functionality is to be a negotiator between body 21 of air inlet pipe 7 and the machine structure 7′.

Air inlet pipe 7 shown in FIG. 10 in which has two elongations of roof 32 and floor 30 of air inlet pipe 7. It is possible the air inlet pipe will have a quick release unit of a T-shape type 31 as shown in this FIG. 10 however it is not restricted to it. It is possible it has recess 3 as shown in this FIG. 10 or two or none. It is possible the air inlet pipe will be divided into two parts by a transverse section as described in FIG. 2, a cross section as in FIG. 8 or none as in the present case.

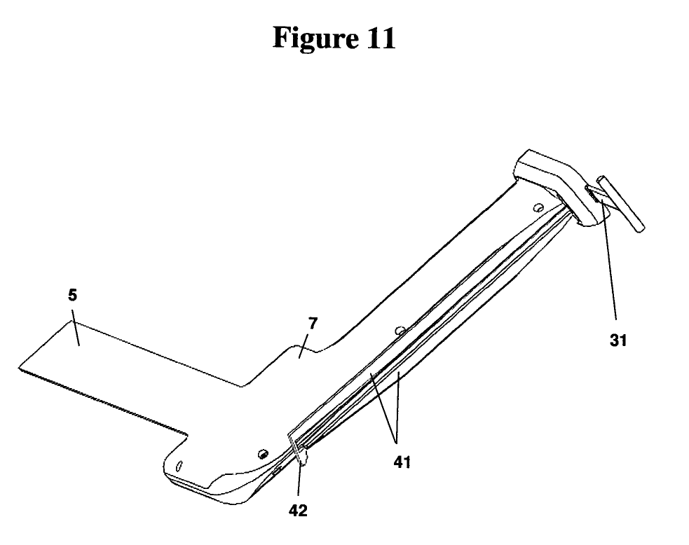

Air inlet pipe 7 shown in FIG. 11 in which apparatus 7 has two flexible recesses 41 projecting from the area connecting to machine 30 (FIG. 9), enabling sheets of material (not shown) to run between them as they are in an “open” position. After the material was passed between them recesses 41 can be attached by snap structure 42, “closing” on the material. This embodiment has recess 5 projecting from the air exit area for guiding the material to the machine's draw mechanism. The embodiment can be divided in a transverse section, cross section etc. It can contain a quick release unit of a T-shape type 31 as shown in this Fig however it is not restricted to it.

Although the invention has been described in conjunction with specific embodiments thereof, it is evident that many alternatives, modifications and variations will be apparent to those skilled in the art, accordingly, it is intended to embrace all such alternatives, modifications and variations that fall within the spirit and broad scope of the appended claims.

1. A replaceable apparatus carrying a pre-threaded material towards a packaging machine; said apparatus being connected to said machine via a suitable structure.

2. The replaceable apparatus of claim 1, wherein said apparatus comprises a filler appliance being a guide to the material, a separator and filling means for the filler of th a bag.

3. The replaceable apparatus of claim 1, further includes an air inlet pipe being shaped to fit the specific socket/structure in the packaging machines which air inlet pipe contains a quick release enabling unit.

4. The replaceable apparatus of claim 4, wherein said quick release enabling unit comprises a quick release T-shape unit or a quick release ring unit.

5. The replaceable apparatus of claim 3, wherein said air inlet pipe is disposable.

6. The replaceable apparatus of claim 3, wherein said air inlet pipe is provided with a recess projecting from the connection area suitably having a slot.

7. The replaceable apparatus of claim 3, wherein said air inlet pipe comprises a transverse section dividing said air inlet pipe into an upper part and a lower part, each part having a recess, the upper and lower parts being later to be connected to one another by a snap-on structure.

8. The replaceable apparatus of claim 3, wherein said air inlet pipe comprises two parts which are the pipe itself and a connector enabling it to be connected to the machine.

9. The replaceable apparatus of claim 3, wherein said air inlet pipe is in which the portion where the air leaves the air inlet pipe having an extended projection, having any suitable form and length, which projection serves as a guide to the material to reach the packaging machine.

10. The replaceable apparatus of claim 3, wherein said air inlet pipe is made from a suitable thermoplastic material such as polyurethane, polypropylene, polyethylene, ABS and PVC.

11. A method for threading and inserting the apparatus as described in claim 1, wherein the apparatus is inserted into the material so it is wrapped all around by the material except for an opening where the apparatus is connected to at least one of the machine and a recess.

12. The method of claim 11, wherein threading and inserting the apparatus into the material is done by means of welds.

13. The method of claim 11, wherein threading and inserting the apparatus into the material is done by means of welds and disabling an initial material movement in two specific directions.

14. The method of claim 11, wherein threading and inserting the apparatus into the material is done by means of welds and disabling initial material movement in three different directions.

15. The method of claim 11, wherein threading the air inlet pipe with a 2-ply material or c-fold material is done by threading the material's ends between a body of an air inlet pipe and its recess.

16. The method of claim 11, wherein threading the air inlet pipe is done by threading the material edges between each part's body and recess, and attaching and forming a unit from these two parts by applying pressure and locking snap-on structures.

17. The method of claim 11, wherein threading the air inlet pipe is performed by inserting the air inlet pipe into the material connecting it to a connector part and threading the material through a recess or slotted recess in the connector part.

18. The method of claim 11, wherein threading an air inlet pipe comprises providing two flexible recesses by inserting an air inlet pipe portion into the material, while the two recesses are in an “open” position, after the air inlet pipe is inserted binding the two recesses using a snap structure for “closing” them.

19. The method of claim 11, wherein a portion where air leaves the apparatus, excess material is left and squeezed; such that when air blows through a tunnel, excess material is blown and thrown in a direction of a draw mechanism of the machine, thus reaching it.

20. The method of claim 11, wherein said method is performed either with a roll of thermoplastic material or with a fan folded thermoplastic material.

21. A machine having a replaceable apparatus as described in claim 1, having a tunnel enabling filler flow through it into the replaceable apparatus and where a connection between the tunnel and the apparatus is located in an easy access area.

22. The machine of claim 21, further including a sensor device comprising at least one of a micro switch and an optic eye sensor.
